(19) United States
(12) Patent Application Publication
(10) Pub. No.: US 2011/0154698 A1
(43) Pub. Date: Jun. 30, 2011

(54) Multimedia Greeting Card

(76) Inventor: Hao-Wei Lin, Wuri Township (TW)

(21) Appl. No.: 12/647,587

(22) Filed: Dec. 28, 2009

(51) Int. Cl. G09F 1/00; G09G 3/36

(52) U.S. Cl. 40/124.03; 345/87

(57) ABSTRACT

A multimedia greeting card in accordance with the present invention has a base, a control circuit board, a screen, a speaker and a cover. The control circuit board and the speaker are mounted in the base, and the screen is mounted on the base. The screen and the speaker are electrically connected to the control circuit board. The cover is pivotally mounted on the base. People can record audio-visual information and store data in a storage unit of the control circuit board. When the multimedia greeting card is actuated, the multimedia information is presented by the screen and speaker.

### BACKGROUND OF THE INVENTION

1. Field of the Invention

The present invention relates to a greeting card, and more particularly to a multimedia greeting card capable of presenting audio-visual information.

2. Description of Related Art

For relationship and communication, people send greeting cards to their friends and relatives or the like. A conventional greeting card is usually made of paper and has patterns printed thereon, and people can give it to the recipient.

However, the conventional greeting card is printed by unchangeable patterns for special use, like Christmas, birthday, anniversary, condolences or the like. People can only choose cards of predetermined types, but sometimes a most proper type is not available. In addition, the conventional greeting card can only present static words or patterns, interest and attraction is limited and some people struggle to express their greeting and feelings just using words.

Therefore, the present invention provides a multimedia greeting card to overcome the aforementioned problems.

### SUMMARY OF THE INVENTION

An objective of the invention is to provide a multimedia greeting card capable of presenting audio-visual information to express sender's greeting more directly and exactly.

The multimedia greeting card in accordance with the present invention has a base, a control circuit board, a screen, a speaker and a cover. The control circuit board and the speaker are mounted in the base, and the screen is mounted on the base. The screen and the speaker are electrically connected to the control circuit board. The cover is pivotally mounted on the base. People can record audio-visual information and store data in a storage unit of the control circuit board. When the multimedia greeting card is actuated, the multimedia information is presented by the screen and speaker.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a preferred embodiment of a multimedia greeting card in accordance with the present invention open;

FIG. 2 is a perspective view of the multimedia greeting card in FIG. 1 closed;

FIG. 3 is an enlarged side view of the multimedia greeting card in FIG. 1;

FIG. 4 is a block diagram of a multimedia greeting card in accordance with the present invention;

FIG. 5 is a perspective view of a multimedia greeting card in accordance with the present invention showing an insertion of an interchangeable card; and

FIG. 6 is a perspective view of a multimedia greeting card in accordance with the present invention shown with the interchangeable card; and

FIG. 7 is a perspective view of a multimedia greeting card in accordance with the present invention shown words written on the cover.

### DETAILED DESCRIPTION OF PREFERRED EMBODIMENT

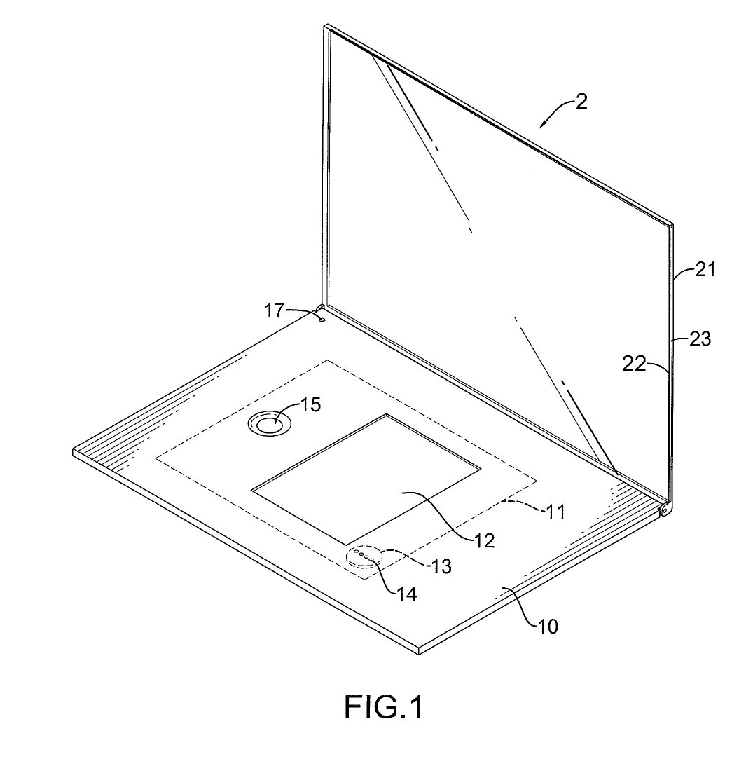

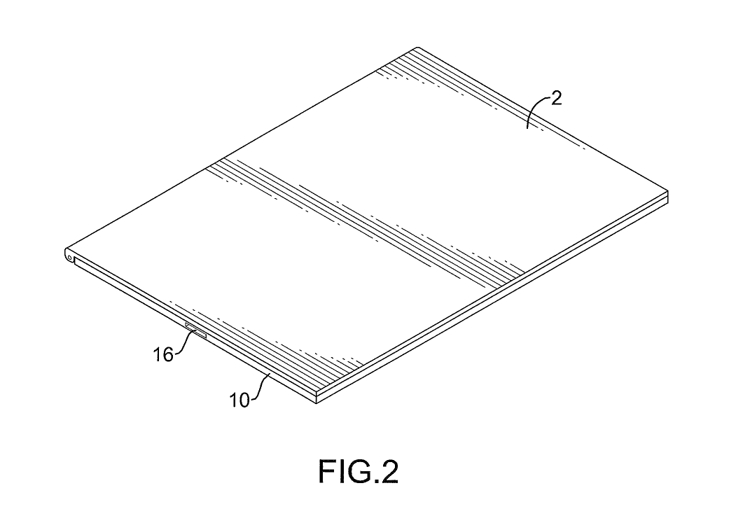

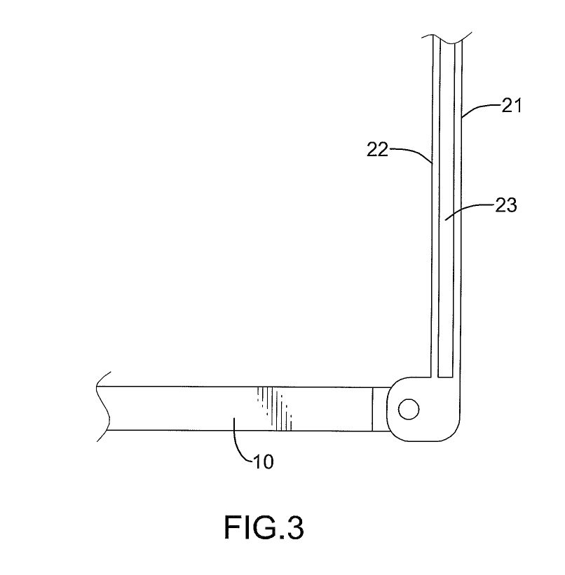

With reference to FIGS. 1 to 3, a multimedia greeting card in accordance with the present invention comprises a base (10), a control circuit board (11), a screen (12), a speaker (13), a button (15), a connecting port (16), a cover (2) and an optional sensor (17). The control circuit board (11) is mounted in the base (10) and has a power unit (114), a control unit (110) and a storage unit (112). The screen (12) is mounted on a top surface of the base (10) and is electrically connected to the control circuit board (11), wherein the screen (12) may be a liquid crystal display. The speaker (13) is mounted in the base (10) and is electrically connected to the control circuit board (11). The speaker (13) may have multiple audio holes (14) formed through the top surface of the base (10). The button (15) is mounted on the base (10) and is electrically connected to the control circuit board (11) to actuate or stop the multimedia greeting card. The connecting port (16) is electrically connected to the control circuit board (11) and may be mounted on a side of the base (10). The cover (2) is pivotally mounted on the base (10) and has an outer panel (21), an inner panel (22) and a holding space (23). The outer panel (21) and the inner panel (22) of the cover (2) may be transparent so people can see through the inner panel (22) the cover (2). The holding space (23) is formed between the outer panel (21) and the inner panel (22). The cover (2) may have a slot formed through an edge of the cover (2), The cover (2) may have a slot formed through an edge of the cover (2) and connected to the holding space (23) of the cover (2).

The sensor (17) is mounted between the base (10) and the cover (2) and may be mounted on the top surface of the base (10) to sense whether the cover (2) is opened or closed, wherein the sensor (17) may be an optical sensor or a contact sensor.

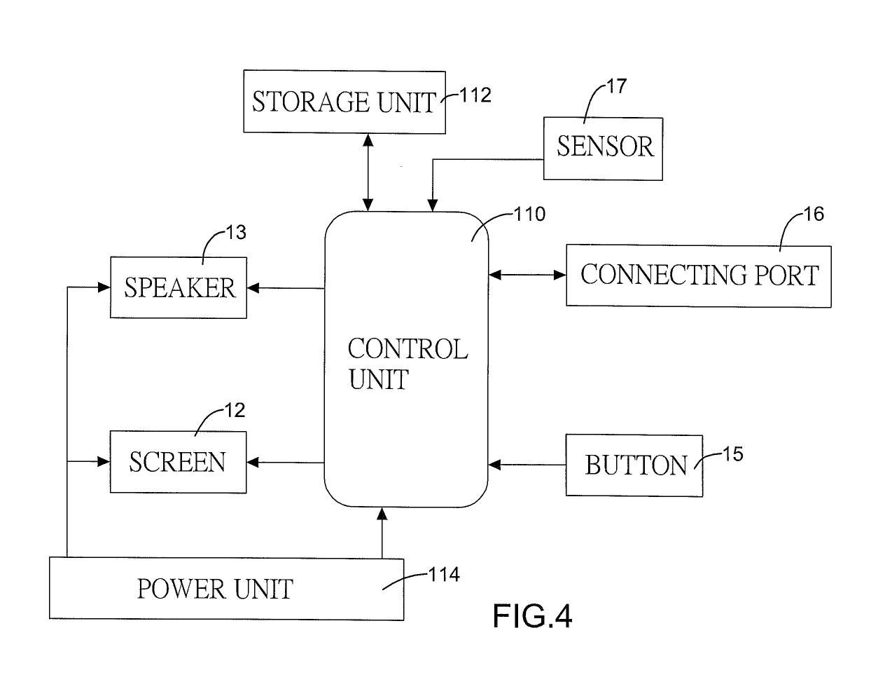

With reference to FIG. 4, people can transmit video, audio or digital photograph into the storage unit (112) of the control circuit board (11) by the connecting port (16). When a recipient opens the multimedia greeting card, the sensor (17) will send a signal to the control unit (110), and audio-visual data recorded by sender are presented by the screen (12) and the speaker (13). In addition, the recipient can also operate the multimedia greeting card by pressing the button (15).

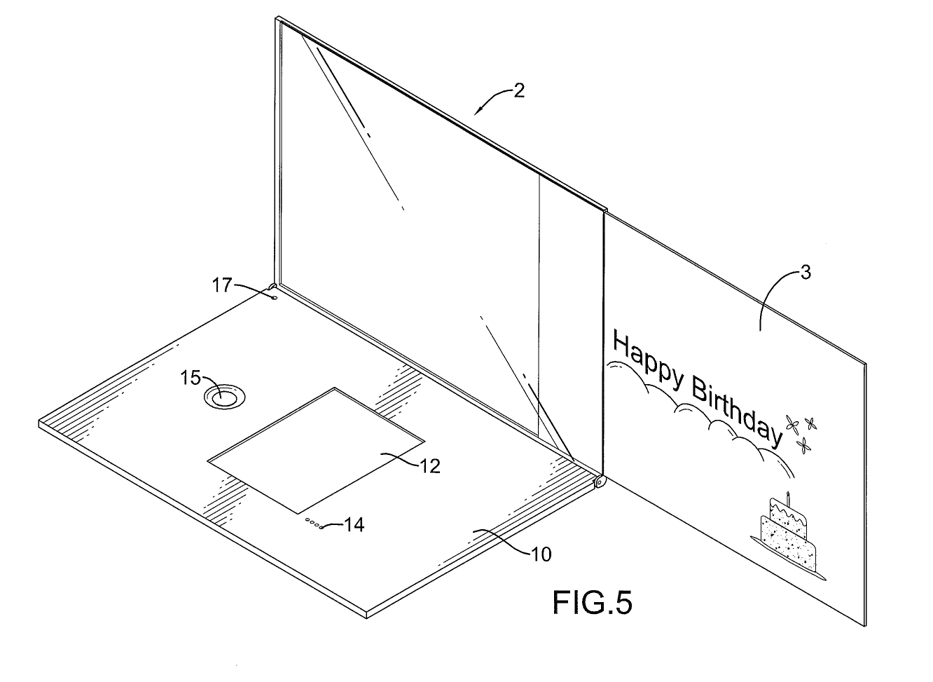

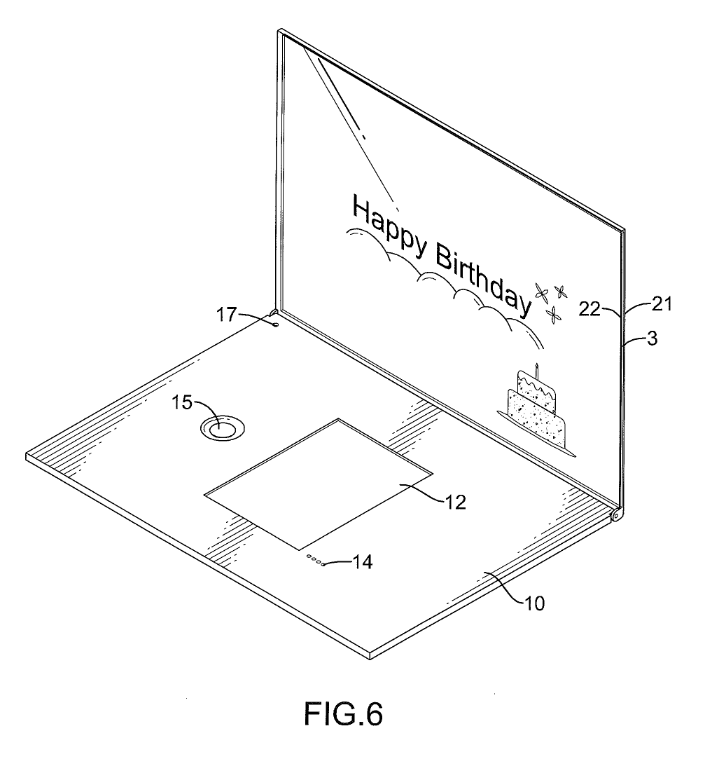

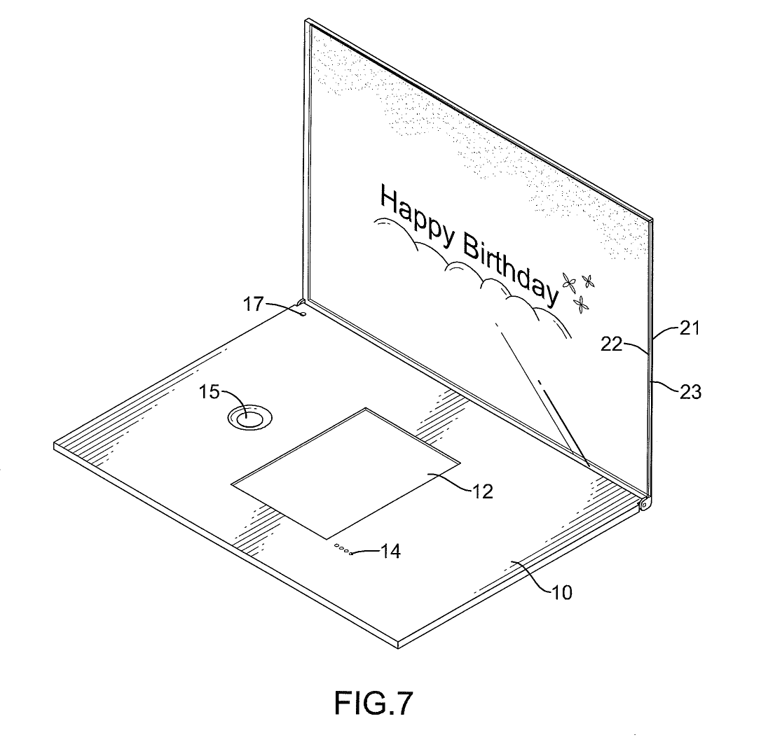

With reference to FIGS. 5 to 6, people can write greeting words on an interchangeable card (3) and insert it into the holding space (23) of the cover (2). With reference to FIG. 7, people can also write on the cover (2) directly, besides recording multimedia information.

The multimedia greeting card in accordance with the present invention can exactly express sender's greeting and feeling by presenting audio-visual information. In addition, dynamic display can attract receiver's attention and add interest to the greeting card.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A multimedia greeting card comprising:
a base;
a control circuit board mounted in the base and having a power unit, a control unit and a storage unit;
a screen mounted on the base and electrically connected to the control circuit board;
a speaker mounted in the base and electrically connected to the control circuit board;
a button mounted on the base and electrically connected to the control circuit board;
a connecting port mounted on the base and electrically connected to the control circuit board; and
a cover pivotally mounted on the base and having an outer panel, an inner panel and a holding space formed between the outer panel and the inner panel.

2. The multimedia greeting card as claimed in claim 1, wherein the cover has a slot formed through an edge of the cover and communicating with the holding space.

3. The multimedia greeting card as claimed in claim 1, wherein the outer panel and the inner panel of the cover are transparent.

4. The multimedia greeting card as claimed in claim 2, wherein the outer panel and the inner panel of the cover are transparent.

5. The multimedia greeting card as claimed in claim 1, wherein the outer panel of the cover is opaque and the inner panel is transparent.

6. The multimedia greeting card as claimed in claim 2, wherein the outer panel of the cover is opaque and the inner panel is transparent.

7. The multimedia greeting card as claimed in claim 1, wherein the multimedia greeting card has a sensor mounted between the base and the cover and connected to the control circuit board to sense whether the cover is opened and actuates the multimedia greeting card.

8. The multimedia greeting card as claimed in claim 4, wherein the multimedia greeting card has a sensor mounted between the base and the cover and connected to the control circuit board to sense whether the cover is opened and actuates the multimedia greeting card.

9. The multimedia greeting card as claimed in claim 6, wherein the multimedia greeting card has a sensor mounted between the base and the cover and connected to the control circuit board to sense whether the cover is opened and actuates the multimedia greeting card.

10. The multimedia greeting card as claimed in claim 8, wherein the sensor is an optical sensor.

11. The multimedia greeting card as claimed in claim 9, wherein the sensor is an optical sensor.

12. The multimedia greeting card as claimed in claim 8, wherein the sensor is a contact sensor.

13. The multimedia greeting card as claimed in claim 9, wherein the sensor is a contact sensor.

14. The multimedia greeting card as claimed in claim 1, wherein the screen is a liquid crystal display.

15. The multimedia greeting card as claimed in claim 2, wherein the multimedia greeting card further comprises of an interchangeable card mounted in the holding space connecting to the slot of the cover.
